(19) United States
(12) Patent Application Publication
(10) Pub. No.: US 2010/0002618 A1
(43) Pub. Date: Jan. 7, 2010

(54) Radio Communication with a Repeater

(76) Inventors: Josef Martin Eichinger, Neufinsing (DE); Egon Schulz, Munchen (DE); Wolfgang Zirwas, Munchen (DE)

Correspondence Address: STAAS & HALSEY LLP, SUITE 700, 1201 NEW YORK AVENUE, N.W., WASHINGTON, DC, 20005, US

(21) Appl. No.: 12/083,547

(22) PCT Filed: Sep. 21, 2006
(86) PCT No.: PCT/EP2006/066607

§ 371 Date: Aug. 11, 2009

(30) Foreign Application Priority Data
Oct. 13, 2005 (DE) 102005049103.0

(51) Int. Cl. H04B 7/14

(52) U.S. Cl. 370/315

(57) ABSTRACT

A first radio station receives a message in a first frequency band from a second radio station and passes the message to a third radio station in a second frequency band, where the width of the first frequency band differs from the width of the second frequency band. The modulation of the data in the message is maintained unchanged and the first radio station is not required to perform decoding of the message.

### CROSS REFERENCE TO RELATED APPLICATIONS

This application is based on and hereby claims priority to German Application No. 10 2005 049 103.0 filed on Oct. 13, 2005, the contents of which are hereby incorporated by reference.

### BACKGROUND

Described below is a method for communicating by radio, in which a radio station receives a message in a first frequency band and forwards it in a second frequency band.

In radio communication systems, messages, for example with voice information, image information, video information, SMS (Short Message Service), MMS (Multimedia Messaging Service) or other data are transmitted via a radio interface between transmitting and receiving radio station with the aid of electromagnetic waves. Depending on the actual embodiment of the radio communication system, the radio stations can be different types of subscriber stations or radio stations in the network such as repeaters, radio access points or base stations. In a mobile radio communication system, at least some of the subscriber stations are mobile radio stations. The electromagnetic waves are radiated with carrier frequencies which are in the frequency band provided for the respective system.

Mobile radio communication systems are frequently embodied as cellular systems, e.g. in accordance with the GSM (Global System for Mobile Communication) standard or UMTS (Universal Mobile Telecommunications System), with a network infrastructure, e.g., of base stations, facilities for supervising and controlling the base stations and other facilities in the network. Apart from these cellular hierarchic radio networks organized over a wide area (supralocal), there are also wireless local area networks (WLANs) with a radio coverage which, as a rule, is much more limited in space. Examples of various standards of WLANs are HiperLAN, DECT, IEEE 802.11, Bluetooth and WATM.

Radio stations can communicate with one another directly only if both of them are located in the radio coverage area of the other radio station in each case. If direct communication is not possible, messages can be transmitted between these radio stations via other radio stations which—by forwarding the messages—act as relay radio stations or repeaters, respectively. Such message forwarding can be carried out both by subscriber stations and by radio stations in the network depending on the actual embodiment of the radio communication system. Messages can be forwarded, for example in a WLAN, between a radio access point and subscriber stations at a great distance from the radio access point. In an ad hoc mode of a radio communication system, too, subscriber radio stations can communicate with one another via one or more hops (Hop or Multi-Hop, respectively), without switching facilities such as, e.g. base stations or radio access points being interposed, in that, in the case of a transmission of messages from one subscriber station to another subscriber station outside its radio coverage area, the messages are forwarded by other subscriber stations.

### SUMMARY

Described below is a method and a device for transmitting a message via a number of hops.

In the method for communicating by radio, a radio station receives a message in a first frequency band from a first radio station and forwards the message to a second radio station in a second frequency band. The width of the first and of the second frequency band differ from one another. Compared with the data of the received message, the data of the forwarded message are unchanged with respect to their modulation.

The radio station can be, e.g. a repeater or a relay radio station, respectively, which serves for forwarding messages between radio stations. The frequency bands used for reception and for forwarding differ from one another with respect to their bandwidth. This can be implemented by one of the frequency bands being contained in the other one or by the two frequency bands partially overlapping or by the two frequency bands not having any overlap and thus no frequencies common to the two frequency bands.

The data of the forwarded message do not differ from the data of the received message with respect to their modulation. This means that the same modulation method is applied for both transmissions of messages, i.e. both for the transmission to the radio station and for the transmission from the radio station. The forwarded message can be any message, e.g. a message for signaling or with payload information.

As a development, the radio station forwards the message without previous decoding and recoding of the message. Although, according to this development, the radio station can carry out processing of the message such as, e.g. converting the received message from the high-frequency band into baseband, and analog/digital conversion, but the message is not decoded. Decoding would be necessary for performing baseband processing such as e.g. demodulation/modulation and coding. It is therefore also advantageous if the radio station forwards the message without previous demodulation and remodulation of the message.

According to an advantageous embodiment, the radio transmission in the first frequency band includes a radio emission by the first further radio station, directed at the radio station, and the radio transmission in the second frequency band is a component of a joint transmission method. The latter means that, apart from a radio station, at least one other radio station transmits the message at the same time in the second frequency band to the second further radio station so that the messages received in multiple can be combined by the second further radio station.

It is advantageous if the radio station receives a further message from the first further radio station in the first frequency band and forwards the further message to a third further radio station in a third frequency band which differs from the second frequency band. This means that the radio station receives messages for a number of addressees in the first frequency band and forwards these messages to the different addresses in different frequency bands. As an alternative, it is also possible that the radio station receives a further message from a third further radio station in a third frequency band which differs from the first frequency band and forwards the further message to the second further radio station in the second frequency band. In this case, the radio station receives messages from different transmitters in different frequency bands and forwards these different messages to the same receiver in the same frequency band.

As a development, the radio station and the second further radio station are stationary radio stations and the first further radio station is a mobile radio station and the width of the first frequency band is smaller than the width of the second frequency band. As an alternative, it is also possible that the radio station and the first further radio station are stationary radio stations and the second further radio station is a mobile radio station, the width of the first frequency band being greater than the width of the second frequency band. In both cases, a wide frequency band is used for the transmission between stationery radio stations and a narrower frequency band is used for the transmission between a stationary radio station and a mobile radio station.

The radio station receives a message in a first frequency band from a first further radio station and forwards the message in a second frequency band to a second further radio station. In this case, the width of the first frequency differs from the width of the second frequency band. Furthermore, the data of the message forwarded are modulated in the same way as the data of the message received.

The radio station may be a stationary repeater in a network, including means for carrying out the method and the embodiments and developments described below.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of a section from a radio communication system,

FIG. 2 is a time versus frequency graph shown an allocation of radio resources to hops of a multi-hop transmission,

FIG. 3 is a block diagram of a section from a multi-hop node.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

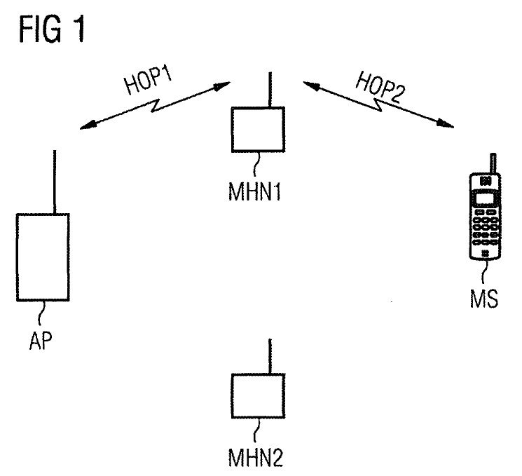

The section from a radio communication system, shown in FIG. 1, shows the radio access point AP, the two multi-hop nodes MHN 1 and MHN 2 and the subscriber station MS. The radio access point AP is preferably a radio facility in the network of a WLAN; as an alternative, the radio access point AP can also correspond, e.g. to a base station of an IEEE 802.16e or UMTS system. The subscriber station MS a mobile terminal, is located at such a distance from the radio access point AP that direct radio communication between the radio access point AP and the subscriber station MS is not possible or not advantageous because of a lack of transmission quality. For this reason, the stationary multihop node MHN 1 in the network is used for forwarding messages between the radio access point AP and the subscriber station MS.

In the downward direction, messages for the subscriber station MS from the radio access point AP are first transmitted via a first hop HOP 1 between the radio access point AP and the multihop node MHN 1 and then via a second hop HOP 2 between the multihop node MHN 1 and the subscriber station MS. The method can be applied to communication in the upward and/or downward direction, i.e. both to transmissions of messages from the radio access point AP to the subscriber station MS and to transmission messages from the subscriber station MS to the radio access point AP. Between the subscriber station MS and the radio access point AP, messages can be transmitted via more than one multihop node.

The more hops are needed, the longer the transmission of messages involving multihop nodes will take. It is advantageous, therefore, if connections with high data rates and thus short transmission periods are used for the individual hops. It is appropriate, therefore, if line-of-sight (LOS) connections exist between the stationary radio access point AP and the stationary multihop nodes MHN 1 and MHN 2. Such line-of-sight connections can be implemented, e.g. by mounting antennas on roofs of houses. For the connections between the stationary radio stations, a highly directional emission of the messages can be used. Thus, no unwanted interferences arise between the messages which are transmitted between the radio access point AP and the multihop node MHN 1, on the one hand, and between the radio access point AP and the multihop node MHN 2, on the other hand. In this way, it is possible to use the same radio frequencies for the communication of the radio access point AP with different multihop nodes.

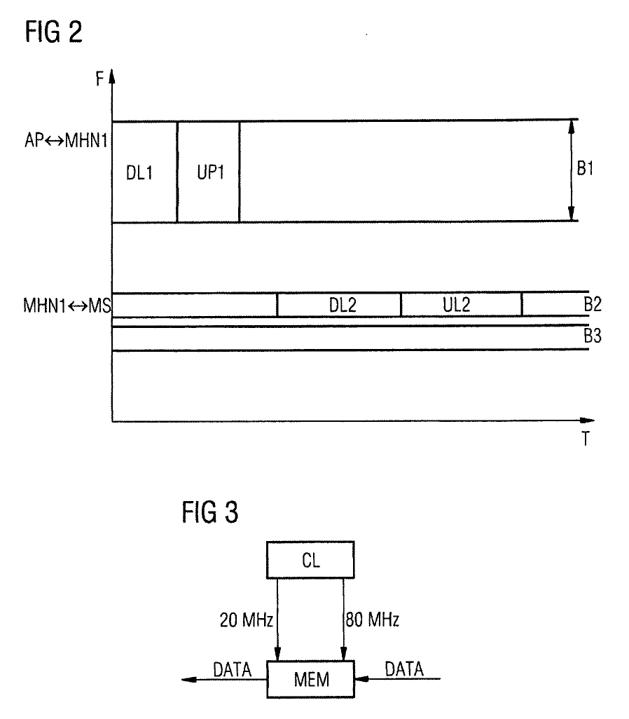

FIG. 2 shows the radio resources used for the transmission via the two hops HOP 1 and HOP 2 between the radio access point AP and the subscriber station MS, the frequency F being plotted upward and the time T being plotted towards the right. A wide frequency band B1 is used for the transmission via the first hop between the radio access point AP and the multihop node MHN 1. In this case, a first period of time DL1 is available for the transmission from the radio access point AP to the multihop node MHN 1 and a second period of time UL1 is available for the transmission from the multihop node MHN 1 to the radio access point AP. As shown in FIG. 2, the two periods of time DL1 and UL1 can be of equal length. In the case of an asymmetric traffic volume, e.g. if more information has to be sent out from the radio access point AP to subscriber stations than in the reverse direction, a length of the time interval DL1 and UL1 is available which differs from one another.

As already explained, a highly directional emission is used for the communication between the radio access point AP and the multihop node MHN 1. The frequency band B1 can thus be the same frequency band B1 for communication between the radio access point AP and all multihop nodes used by it for forwarding messages. In this arrangement, the position in time and the length of the time intervals DL1 and UL1 can differ from multihop node to multihop node.

Similarly, the same frequency band B1 can be used for communication from further radio access points, which may be present, with multihop nodes. The same also applies to communication between different multihop nodes in the case where the transmission of messages between the radio access point AP and a subscriber station needs more than two hops. Overall, the frequency band B1 is thus used for all communication between radio access points and multihop nodes, i.e. for all communication in which no subscriber station is involved, highly directional emissions being used for all these communications. With respect to frequency band B1, a frequency reuse factor of 1 is thus used.

Communication between the multihop node MHN 1 and the subscriber station MS takes place in frequency band B2 which is narrower than frequency band B1. For the communication between the multihop node MHN 1 and the subscriber station MS, a time interval DL2 exists for sending out messages from the multihop node MHN 1 to the subscriber station MS and a time interval UL2 for sending out messages from subscriber station MS to the multihop node MHN 1. The time intervals DL2 and UL2 can be of equal or different length in dependence on the traffic volume.

To avoid interference between signals which are exchanged between the multihop node MHN 1 and the subscriber station MS, with signals which are exchanged between the multihop node MHN 1 and other subscriber stations, these signals can be separated in the frequency domain. For example, FIG. 2 shows frequency band B3 which can be used by the multihop node MHN 1 for communication with another subscriber station. The time intervals for the upward and the downward direction of frequency band B3 can have the same or different positions in time as the corresponding time intervals of frequency band B2.

With respect to the frequency bands which are used for communication with subscriber stations, a frequency reuse factor of greater than 2 is used. Due to the fact that a number of frequency bands are needed for communication with subscriber stations, the use of a narrow frequency band presents itself for communication with subscriber stations whereas the same frequency band is used for all communication for the other hops in which no subscriber stations are involved.

As an alternative to separating the communications between the multihop node MHN 1 and various subscriber stations in the frequency domain, a separation in the space domain can also be used, as, e.g. by joint transmission or spatial multiplexing.

Whereas frequency bands B1 and B2 are separated in the frequency domain in FIG. 2, it is also possible that frequency band B2 is a component or a subset of frequency band B1. Using the same frequency radio resource, i.e. frequency band B2, both for the first and the second hop is made possible by the directional permission of the transmission over the first hop. This prevents interference between signals of the two hops. An advantage of using the same frequency for forwarding and for receiving messages is that different multihop nodes do not need to be precisely synchronized in time and frequency since any frequency shift which may be present in the conversion into baseband, is compensated again by the subsequent conversion into the radio-frequency band.

The bandwidths B2 or B3 which are used for communication with subscriber stations can be scaled in width. i.e. subscriber stations can be variably assigned a certain range of radio resources, e.g. in dependence on the requirements of the service used by them. The system considered can be, e.g. an OFDM system so that certain numbers of OFDM subcarriers can be assigned individually to a subscriber. This correspondingly also applies to the width of the frequency band B1, i.e. this, too, can be scaled and thus adapted to the data rate requirement of the respective connection. In spite of the fundamental scalability of the data rates for all hops of a connection, it holds true that the bandwidth with which the multihop node adjacent to a subscriber station communicates with this subscriber station is smaller than the data rate with which the multihop node receives the messages intended for the subscriber station or, respectively, forwards the messages received from the subscriber station.

In the text which follows, the case is considered that a message is to be transmitted from the radio access point AP to the subscriber station MS via the multihop node MHN 1. The radio access point AP sends out the message within the time interval DL1 to the multihop node MHN 1. The latter receives the message and forwards it to the subscriber station MS within the time interval DL2. Since a greater bandwidth, and thus a higher data rate, is available for the first hop HOP 1 between the radio access point AP and the multihop node MHN 1 than for the second hop HOP 2 between the multihop node MHN 1 and the subscriber station MS, the transmission via the second hop HOP 2 takes longer than the transmission via the first hop HOP 1.

The multihop node MHN 1 is an amplify-and-forward multihop node. This means that the multiphop node MHN 1 only amplifies the received messages before forwarding them without, however, carrying out any baseband processing of the received information. In the case of baseband processing, the received messages is decoded whereupon, e.g., the modulation method and the error protection coding can be changed. By this means, a message to be transmitted can be adapted to the current radio channel. Since the multihop node MHN 1 does not perform any baseband processing, received information is sent out by the multihop node MHN 1 with the same modulation method which has also been used for sending out the message to the multihop node MHN 1.

Apart from the advantage of gaining time due to the more rapid forwarding, using amplify-and-forward multihop nodes is of advantage, in particular with regard to joint transmission methods. Joint transmission is the simultaneous transmission of messages by a number of multihop nodes to a number of subscriber stations. This corresponds to a MIMO (multiple input multiple output) system in which the transmitting antennas are distributed to the various multihop nodes and the receiving antennas are distributed to the various subscriber stations. Thus, for example, a message from the radio access point to the subscriber station MS can be transmitted via the two multihop nodes MHN 1 and MHN 2. In this case, the radio access point AP carries out suitable processing of the messages sent to the two multihop nodes MHN 1 and MHN 2, taking into consideration the various radio channels. As a result, the messages sages are such that at the location of the subscriber station MS, a constructive superposition of the messages intended for the subscriber station from the multihop node MHN 1 and the multihop node MHN 2 occurs, and a destructive interference of messages intended for other subscriber stations. If the multihop nodes MHN 1 and MHN 2 were to decode the messages by baseband processing and change transmission paramaters, the phase relationship between the messages emitted by the multihop nodes MHN 1 and MHN 2, needed for joint transmission, would be lost. This disadvantageous effect does not occur in amplify-and-forward multihop nodes.

To change the data rate or the bandwidth used for the transmission without any baseband processing, the multihop node MHN 1 is configured as explained with reference to FIG. 3. FIG. 3 only shows a section of the multihop node MHN 1 including the memory MEM and the clock generator CL. The memory MEM is FIFO (first in first out) memory with respect to messages of the subscriber station MS.

The received data DATA which—coming from the right according to the illustration—are read into the memory, are digital data which are present after the conversion of the received message into baseband and after the analog/digital conversion. The data DATA to be sent out which—going towards the left according to the illustration—are read out of the memory are the same digital data which are present before digital/analog conversion and before conversion into baseband. The clock generator CL determines the sampling rate of the data DATA, i.e. the rate at which the data DATA are read in and out of the memory MEM. FIG. 3 shows by way of example the case where the data DATA are read into the memory MEM with a sampling rate of 80 MHz and are read out of the memory MEM with a sampling rate of 20 MHz. Since the reading-in rate is higher than the reading-out rate, this corresponds to a transmission in the downward direction, i.e. the multihop node MHN 1 has received the data DATA from the radio access point AP in order to forward them to the subscriber station MS. In the case of a communication in the output direction, the reading-in rate is correspondingly lower than the reading-out rate.

For the purpose of simplification, other components of the multihop node MHN 1 are not shown in FIG. 3. Thus, there can be, e.g. a device for synchronization which recognizes the temporal structure of the data such as, e.g. frame and guard intervals and forwards corresponding information to the clock generator CL which enables the clock generator CL to take into consideration the data structure. Furthermore, a control device can be provided which allocates data from/to various subscriber stations to different queues of the memory MEM and assigns data to be sent out from/to subscriber stations to the corresponding time slots for the transmission.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for communicating by radio, comprising:
receiving, at a first radio station from a second radio station, a first message in a first frequency band;
forwarding the first message from the first radio station to a third radio station using a second frequency band without changing modulation of data in the first message, where the first frequency band has a width different from the width of the second frequency band.

12. The method as claimed in claim 11, wherein said forwarding is performed by the first radio station without decoding and recoding of the first message.

13. The method as claimed in claim 12, wherein said forwarding is performed by the first radio station without demodulation and remodulation of the first message.

14. The method as claimed in claim 13, wherein said forwarding by the first radio station comprises
storing the data of the first message into a memory as the data is read at a first sampling rate; and
reading the data of the first message out of the memory at a second sampling rate different from the first sampling rate.

15. The method as claimed in claim 14,
wherein the first message is transmitted in the first frequency band by a radio emission from the second radio station directed towards the first radio station, and
wherein said forwarding includes generating a radio transmission in the second frequency band that is a component of a joint transmission method.

16. The method as claimed in claim 15, further comprising:
receiving at the first radio station a second message from the second radio station in the first frequency band; and
forwarding the second message from the first radio station to a fourth radio station using a third frequency band different from the second frequency band.

17. The method as claimed in claim 16,
wherein the first and third radio stations are stationary radio stations and the second radio station is a mobile radio station, and
wherein the width of the first frequency band is smaller than the width of the second frequency band.

18. The method as claimed in claim 16,
wherein the first and second radio stations are stationary radio stations and the third radio station is a mobile radio station, and
wherein the width of the first frequency band is greater than the width of the second frequency band.

19. The method as claimed in claim 15, further comprising:
receiving, at the first radio station from a fourth radio station, a second message in a third frequency band different from the second frequency band; and
forwarding the second message from the first radio station to the third radio station using the second frequency band.

20. The method as claimed in claim 19,
wherein the first and third radio stations are stationary radio stations and the second radio station is a mobile radio station, and
wherein the width of the first frequency band is smaller than the width of the second frequency band.

21. The method as claimed in claim 19,
wherein the first and second radio stations are stationary radio stations and the third radio station is a mobile radio station, and
wherein the width of the first frequency band is greater than the width of the second frequency band.

22. A radio station, comprising
means for receiving a message in a first frequency band from another radio station, and
means for forwarding the message in a second frequency band to yet another radio station without changing modulation of data in the message, where the first frequency band has a width different from the width of the second frequency band.

23. The radio station as claimed in claim 22, wherein the radio station does not include means for decoding the message prior to forwarding the message.

24. The radio station as claimed in claim 23, further comprising:
means for storing the data of the message into a memory as the data is read at a first sampling rate; and
means for reading the data of the message out of the memory at a second sampling rate different from the first sampling rate.
